(19) United States
(12) Patent Application Publication
(10) Pub. No.: US 2009/0121846 A1
(43) Pub. Date: May 14, 2009

(54) SYSTEMS AND METHODS FOR COUPLING POWER LINE CONTROL SIGNALS

(75) Inventors: David J. Rye, Kent, WA (US); James R. Phillips, Bellevue, WA (US); George E. Stevenson, Kowloon (HK)

Correspondence Address: BLACK LOWE & GRAHAM, PLLC, 701 FIFTH AVENUE, SUITE 4800, SEATTLE, WA, 98104, US

(73) Assignee: X10 Ltd., Kowloon (HK)

(21) Appl. No.: 12/184,576

(22) Filed: Aug. 1, 2008

Related U.S. Application Data
(60) Provisional application No. 60/953,407, filed on Aug. 1, 2007.

(51) Int. Cl. G05B 11/01

(52) U.S. Cl. 340/310.16

(57) ABSTRACT

Repeater systems and methods for coupling a home automation control signal from a first power line operating on a first phase to a second power line operating on a second phase are provided. A power line control repeater includes a power line control signal transceiver, a wireless signal transmitter, a wireless signal receiver, and a processor. The processor is configured to instruct the transmitting component to transmit wireless signals based on power line signals detected by the power line control signal transceiver and further configured to identify wireless signals received at the wireless signal receiver from a similarly configured repeater and to instruct the transceiver to modulate the power signal based on the received signals. A system includes two repeaters in wireless signal communication.

### PRIORITY CLAIM

This application claims priority to U.S. Provisional Application Ser. No. 60/953,407 filed on Aug. 1, 2007, which is hereby incorporated by reference in its entirety.

### FIELD OF THE INVENTION

This invention relates generally to home automation systems and methods and, more specifically, to systems and methods for controlling electronic devices over power lines in a multiphase environment.

### BACKGROUND OF THE INVENTION

Most houses in North America are fed from a 220 Volt Alternating Current (VAC) power line service that is split into two phases of 110 VAC each in a circuit breaker panel. Signals from a home automation system, such as an X10 controller that uses power lines to transmit electrical signals, are generally transmitted onto a portion of the home wiring that is on one phase. These signals normally couple across to the other phase through the circuit breaker panel. Sometimes, however, due to loading and/or other factors, there is insufficient coupling for the control signals to couple onto wires in the home that are on the other phase. In these situations, the signal typically must go all the way out of the house to a pole transformer, couple through the transformer windings, and come back into the house on the other phase. This reduces the signal amplitude and can result in a signal amplitude on the other phase at some outlet locations that is insufficient to control electronic devices. In some situations, moving a control or a receiving unit to another outlet will fix the problem. However, this does not work for all cases.

Current solutions to this problem have a variety of drawbacks. A home owner can have an electrician couple the signal from one phase to the other by installing a passive phase coupler, an active phase coupler, or a repeater across the home's 220 VAC line from hot to hot (i.e., across any 220 volt breaker). This requires installation by a qualified electrician, thereby increasing cost and decreasing convenience to the home owner. Alternatively, a 220 VAC plug-in coupling unit can be plugged into a 220 VAC outlet to connect and couple both phases. This is a disadvantageous solution because although some homes contain 220 VAC outlets for washers and/or dryers, not all homes have such outlets, with their washers and dryers using an alternative voltage. Additionally, sometimes the washer and/or dryer is hard wired into a 220 VAC power line rather than being plugged into a 220 VAC outlet. In these cases, a 220 VAC plug-in unit would not be usable by the home owner.

### SUMMARY OF THE INVENTION

The present invention comprises a repeater system for coupling a home automation control signal from a first power line operating on a first phase to a second power line operating on a second phase.

In accordance with some examples of the invention, a power line control signal coupler includes a power line control signal transceiver, a wireless signal transmitting component, a wireless signal receiving component, and a processor in signal communication with the power line control signal transceiver, the transmitting component, and the receiving component. The processor is configured to instruct the transmitting component to transmit wireless signals based on power line signals detected by the power line control signal transceiver and further configured to identify wireless signals received at the wireless signal receiving component as originating from a similarly configured power line control signal coupler and to instruct the power line control signal transceiver to modulate the power signal based on the identified wireless signals.

In accordance with other examples of the invention, the power line control signal transceiver includes a power line control signal detecting component and a power signal modulating component.

In accordance with still further examples of the invention, the power line control signal coupler further includes a plug component in signal communication with the power line control signal transceiver. The plug component is configured to plug into a standard household power outlet.

In accordance with yet other examples of the invention, the plug component is configured to plug into a 110 VAC household power outlet.

In accordance with still another example of the invention, the power line control signal transceiver is configured to detect signals encoded with an X10 protocol and modulate the power signal using the X10 protocol.

In accordance with yet another example of the invention, the transmitting component and the receiving component are configured to operate at approximately 310 Megahertz (MHz).

In accordance with further examples of the invention, the power line control signal coupler further includes a port in signal communication with the processor configured such that the processor can accept instructions from a device in signal communication with the port. The processor is further configured to instruct the power line control signal transceiver to modulate the power signal based on the instructions from the device.

In accordance with still further examples of the invention, a power line control signal system includes a first coupling unit and a second coupling unit. Each of the coupling units are configured to detect a power line control signal having a signal control pattern, transmit a wireless signal based on the detected control signal, receive transmitted wireless signals from the other coupling unit, and modulate a power signal on a power line with a coupled power line control signal based on the received wireless signal such that the coupled power line control signal includes the control signal pattern of the detected control signal.

In accordance with yet other examples of the invention, the power line used by the power line control signal system is a 110 VAC power line and each of the first and second coupling units include a standard plug configured to plug into a 110 VAC power outlet.

In accordance with additional examples of the invention, each of the first and second coupling units in the power line control signal system is configured to modulate the power signal using an X10 protocol.

In accordance with other examples of the invention, the wireless signals transmitted by each of the first and second coupling units are at a frequency of approximately 310 MHz.

In accordance with still other examples of the invention, a method of coupling a power line control signal having a control signal pattern from a first power line carrying a first power signal to a second power line carrying a second power signal includes detecting the power line control signal on the first power line using a first coupling unit, transmitting a wireless signal from the first coupling unit based on the detected power line control signal, receiving the wireless signal at a second coupling unit, and modulating the second power signal with a coupled power line control signal based on the received wireless signal using the second coupling unit such that the coupled power line control signal includes the control signal pattern of the detected power line control signal.

In accordance with still further examples of the invention, the second power signal has a different phase than the first power signal.

In accordance with yet other examples of the invention, the second coupling unit is substantially similar to the first coupling unit.

In accordance with additional examples of the invention, the method further includes detecting a power line control signal having a control signal pattern on the second power line using the second coupling unit, transmitting a wireless signal from the second coupling unit based on the power line control signal detected on the second power line, receiving the wireless signal from the second coupling unit at the first coupling unit, and modulating the first power signal with a coupled power line control signal based on the received wireless signal form the second coupling unit using the first coupling unit such that the coupled power line control signal includes the control signal pattern of the detected power line control signal on the second power line.

In accordance with further examples of the invention, the method further includes plugging the first coupling unit into a first standard electrical outlet electrically connected to the first power line and plugging the second coupling unit into a second standard electrical outlet electrically connected to the second power line.

In accordance with other examples of the invention, the first power line is a standard household power line and the second power line is a standard household power line.

In accordance with yet additional examples of the invention, the first power line is a 110 VAC power line and the second power line is a 110 VAC power line.

In accordance with still further examples of the invention, modulating the second power signal includes modulating the second power signal using an X10 protocol and modulating the first power signal includes modulating the first power signal using an X10 protocol.

These and other examples of the invention will be described in further detail below.

### BRIEF DESCRIPTION OF THE DRAWINGS

Preferred and alternative examples of the present invention are described in detail below with reference to the following drawings:

FIG. 1 is a diagram showing a power line control signal coupling unit formed in accordance with an example embodiment of the invention;

FIG. 2 is a diagram showing a power line control signal coupling system formed in accordance with an example embodiment of the invention; and

FIG. 3 is a flowchart of a method of coupling a power line control signal from a first power line to a second power line in accordance with an example embodiment of the invention.

### DETAILED DESCRIPTION OF THE PREFERRED EMBODIMENT

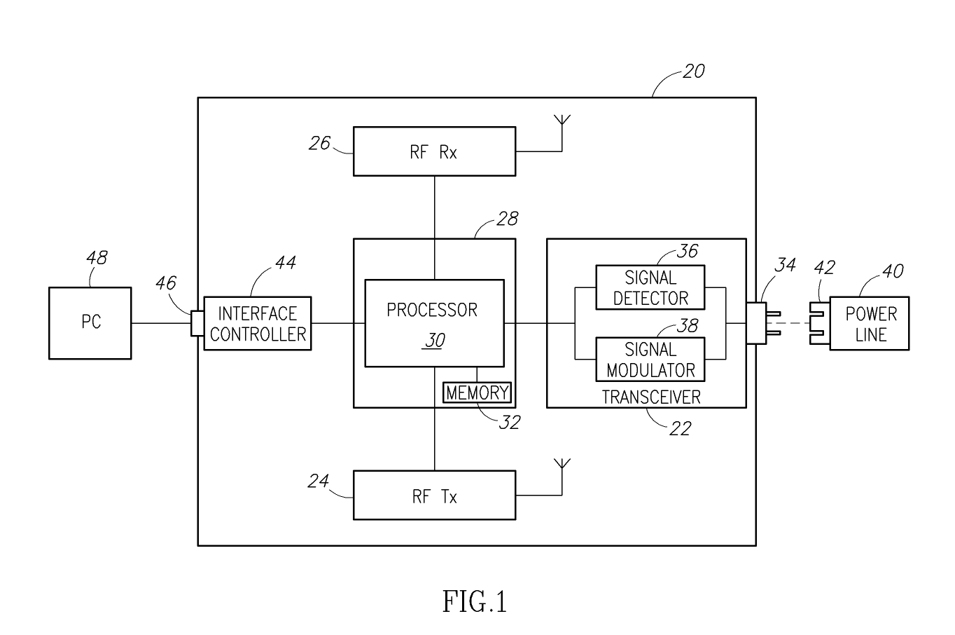

FIG. 1 is a diagram showing a power line control signal coupling unit 20 formed in accordance with an example embodiment of the invention. The coupling unit 20 includes a power line control signal transceiver 22, a wireless signal transmitting component 24, a wireless signal receiving component 26, and a control unit 28 that includes a processor 30 and a memory 32 in data communication with the processor 30. The processor 30 is in signal communication with the power line control signal transceiver 22, the transmitting component 24, and the receiving component 26. In an example embodiment, the transmitting component 24 and the receiving component 26 communicate using a frequency of 310 MHz. However, other frequencies such as 433 MHz or 900 MHz, for example, may also be used in other embodiments.

The control signal transceiver 22 is configured to detect power line control signals on a power line and to modulate a power signal carried on the power line with power control signals. In an example embodiment, the control signal transceiver 22 is configured to detect and modulate control signals on a power line carrying a 110 VAC power signal. The control signals are preferably based on a standard protocol, such as the X10 protocol, so that the coupling unit 20 will be compatible with existing home automation products such as those produced by X10 Ltd. or other products that use the X10 based protocol, for example. However, the control signals may also be based on a custom or non-standard protocol. The transceiver 22 includes a signal detector 36 for detecting power line control signals and a signal modulator 38 for modulating a power signal with control signals in some example embodiments. However, in other embodiments, the transceiver 22 may perform signal detection and signal modulation using different numbers of components. Although the control signal transceiver 22 is included as a component of the coupling unit 20 in a preferred embodiment, other embodiments may not include the control signal transceiver 22 but may instead include a port (not shown) in signal communication with the processor 30 so that the coupling unit 20 can be connected to a separate control signal transceiver.

The memory 32 may include nonvolatile and/or nonvolatile memory components. In an example embodiment, the memory 32 is configured to store programming instructions used by the processor 30. The processor 30 is configured to instruct the transmitting component 24 to transmit wireless signals based on power line signals detected by the power line control signal transceiver 22 and further configured to identify wireless signals received at the wireless signal receiving component 26 as originating from a similarly configured power line control signal coupler and to instruct the power line control signal transceiver 22 to modulate the power signal based on the identified wireless signals.

In an example embodiment, the coupling unit 20 includes a plug 34 configured to be connected to a wall outlet 42. The plug is illustrated as having two prongs that are formed in accordance with typical U.S. or other standards in order to mate with the slots provided in the wall outlet. A third grounding prong may also be provided. The plug is electrically coupled with the transceiver 22 so that it allows the coupling unit 20 to be connected to a power line 40 by plugging the plug 34 into a standard outlet 42 connected to the power line 40. The plug 34 is a standard household plug configured to fit in a 110 VAC outlet in an example embodiment. An optional interface controller 44, such as a Universal Serial Bus (USB) controller for example, is in signal communication with the processor 30. A port, 46, such as a USB port for example, is in signal communication with the interface controller 44 and is configured to allow the coupling unit 20 to be connected to an external device such as a personal computer (PC) 48. Rather than using a direct connection with the port 46, the coupling unit 20 may be connected to external devices in a wireless manner, such as by using Wireless USB (WUSB), in some example embodiments. In still other embodiments, the interface controller 44 may be absent with the port 46 being directly connected to the processor 30 and the processor 30 being configured to perform interface controller functions. Additionally, both the interface controller 44 and the port 46 may be absent in some embodiments. In embodiments that do not include the interface controller 44 and the port 46, the coupling unit 20 functions solely as a power line control signal coupler. In embodiments that do include the interface controller 44 and the port 46, the coupling unit 20 may function as both a power line control signal coupler and as an interface and transceiver for placing control signals sent from an external device such at the PC 48 on a power line.

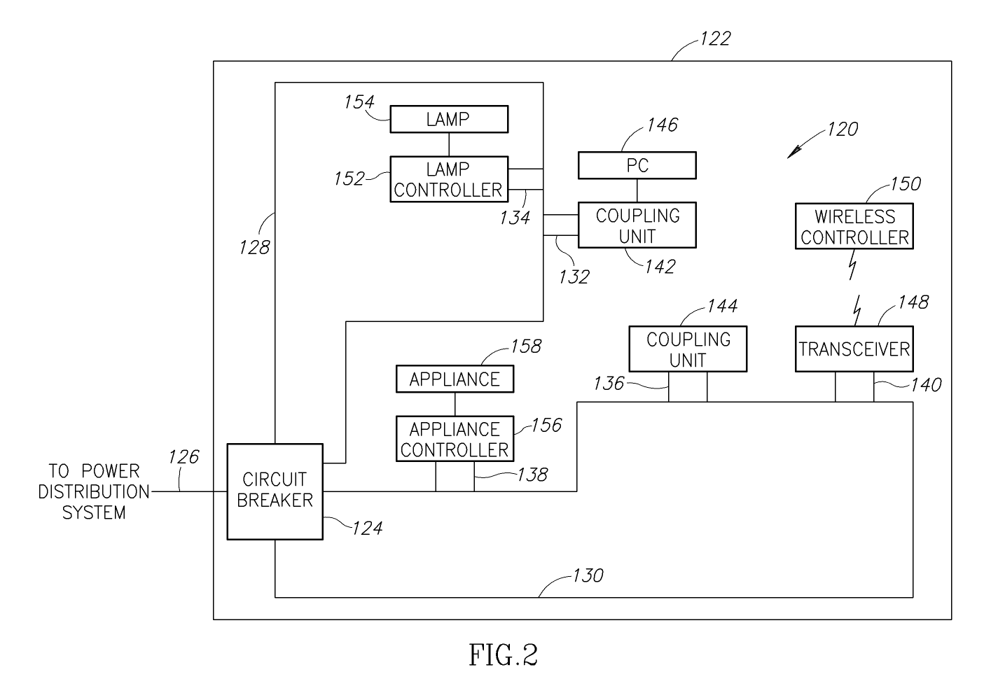

FIG. 2 is a diagram showing an environmental schematic view of a power line control signal coupling system 120 in accordance with an example embodiment of the invention. The signal coupling system 120 is shown in a home 122 that includes a circuit breaker 124 fed by a 220 VAC power line 126. The circuit breaker 124 converts power from the 220 VAC power line 126 into a first 110 VAC power signal having a first phase that is distributed on a first home power line 128 and a second 110 VAC power signal having a second phase that is distributed on a second home power line 130. In an example embodiment, the second phase of the second power line 130 is opposite to the first phase of the first power line 128. A first power outlet 132 and a second power outlet 134 are connected to the first home power line 128. A third power outlet, 136, a fourth power outlet 138, and a fifth power outlet 140 are connected to the second home power line 130. It should be understood that the particular configuration of home power lines, power outlets, and controlled devices is shown and described by way of example only and that the signal coupling system 120 would function with many other configurations.

The power line control signal coupling system 120 includes a first coupling unit 142 and a second coupling unit 144. The first coupling unit 142 is structured in similar fashion to the coupling unit 20 shown in FIG. 1 in an example embodiment, and is shown plugged into the first power outlet 132. The second coupling unit 144, which may also be configured in similar fashion to the coupling unit 20 shown in FIG. 1, is plugged into the third power outlet 136. In an example embodiment, the first coupling unit 142 and the second coupling unit 144 are identical and their locations may be interchanged without affecting the functionality of the system 120. When either the first coupling unit 142 or the second coupling unit 144 detects a power line control signal such as an X10 Powerline Control (PLC) signal, for example, on the home 122 wiring, it wirelessly transmits a signal based on the detected power line control signal to the other coupling unit. The other coupling unit then modulates a power signal on an opposite phase of the home 122 wiring with the detected power line control signal, coupling two phases of the home 122 wiring.

A personal computer 146 is in signal communication with the first coupling unit 142, and is used to provide signal commands to the first coupling unit 142. A wireless transceiver 148 is plugged into the fifth power outlet and is in signal communication with a wireless controller 150 that a user may activate to send signal commands to the wireless transceiver 148 that then modulates the second home power line 130 with the signal commands. A lamp controller 152 is plugged into the second power outlet and is in signal communication with a lamp 154. An appliance controller 156 is plugged into the fourth power outlet and is in signal communication with an appliance 158. In an alternative configuration, a second transceiver (not shown), similar to the wireless transceiver 148 may be connected to the first power line 128 and accept commands from a second wireless controller (not shown), with the PC 146 not being present.

In operation of the example shown, the PC 146 places control signals on the first power line 128 using the coupling unit 142, which is configured to operate as both a coupling unit and as an interface/transceiver for placing control signals on a power line from an external device. If a user desires to control the appliance 158 using the PC 146 using a first control signal pattern, the control signals may not be able to reach the appliance controller 156 through the circuit breaker 124 in some situations, or may become so attenuated by the time they reach the appliance controller 156 that they are no longer effective. However, with the coupling units 142, 144, the control signals from the PC 146 do not need to pass through the circuit breaker 124 to reach the appliance controller 156. The first coupling unit 142 transmits wireless signals based on the first control signal pattern received from the PC 146. The wireless signals from the first coupling unit 142 are received by the second coupling unit 144 which modulates the power signal on the second power line 130 based on the received wireless signals such that the first control signal pattern is placed on the second power line 130. In this manner, control signals present on power lines operating at either of the two phases within the home's wiring are readily transferred to the opposite phase. The first control signal pattern is then able to reach the appliance controller 156 to control the appliance 158.

In similar fashion, a user operating the wireless controller 150 may wish to control the lamp 154. The user activates the wireless controller 150 which transmits a control signal to the transceiver 148 that then places a second signal pattern on the second power line 130 that corresponds to the control signal transmitted by the wireless controller 150. The second coupling unit 144 detects the second signal pattern on the second power line 130 and wirelessly transmits a signal based on the second signal pattern. The first coupling unit 142 receives the transmission from the second coupling unit 144 and modulates the first power line 128 with the second signal pattern. The second signal pattern is detected by the lamp controller 152 which controls the lamp 154 based on the second signal pattern.

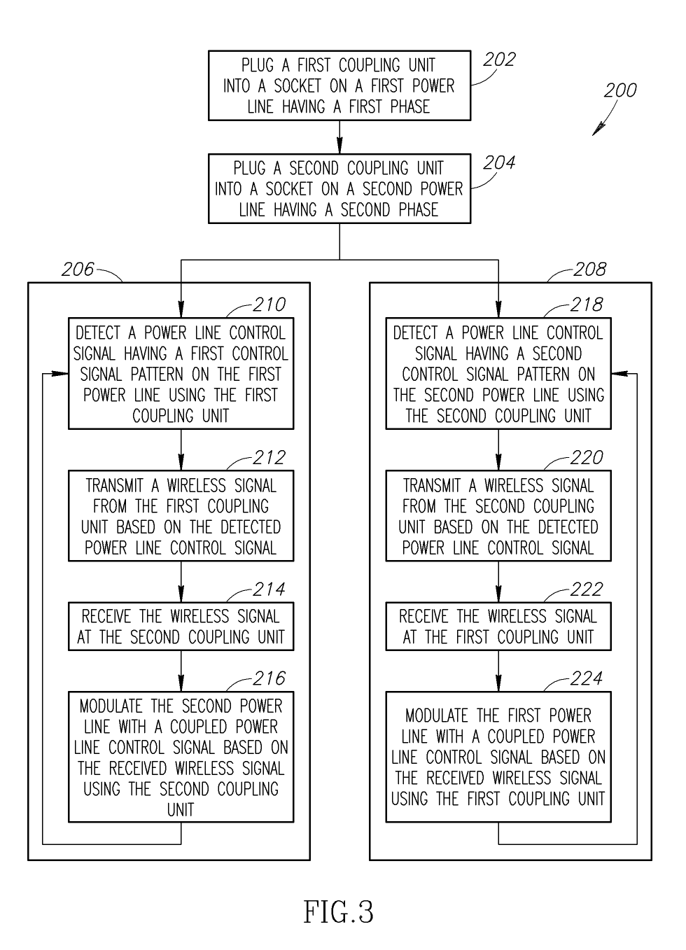

FIG. 3 is a flowchart of a method 200 of coupling a power line control signal from a first power line to a second power line in accordance with an example embodiment of the invention. First, at a block 202, a first coupling unit is plugged into a first standard electrical outlet electrically connected to a first 110 VAC power line carrying a first power signal having a first phase. The first coupling unit 142 may be plugged into the first outlet 132 connected to the first power line 128, for example. Next, at a block 204, a second coupling unit is plugged into a second standard electrical outlet electrically connected to a second 110 VAC power line carrying a second power signal having a second phase. The second coupling unit 144 may be plugged into the third outlet 136 connected to the second power line 130, for example. Then, at a block 206, control signals having a first control signal pattern are detected on the first power line by the first coupling unit and coupled to the second power line. Also, at a block 208, control signals having a second control signal pattern are detected on the second power line by the second coupling unit and coupled to the first power line. The operations in blocks 206 and 208 may be performed in parallel in an example embodiment.

Coupling the first control signal pattern from the first power line to the second power line at the block 206 includes a number of steps in an example embodiment. First, a power line control signal having a first control signal pattern is detected on the first power line using the first coupling unit at a block 210. Then, at a block 212, a wireless signal is transmitted from the first coupling unit based on the detected power line control signal. Next, at a block 214, the wireless signal is received at the second coupling unit. Then, at a block 216, the second power signal is modulated with a coupled power line control signal based on the received wireless signal using the second coupling unit such that the coupled power line control signal includes the first control signal pattern of the detected power line control signal.

In similar fashion, coupling the second control signal pattern from the second power line to the first power line at the block 208 includes a number of steps in an example embodiment. First, a power line control signal having a second control signal pattern is detected on the second power line using the second coupling unit at a block 218. Then, at a block 220, a wireless signal is transmitted from the second coupling unit based on the detected power line control signal. Next, at a block 222, the wireless signal is received at the first coupling unit. Then, at a block 224, the first power signal is modulated with a coupled power line control signal based on the received wireless signal using the first coupling unit such that the coupled power line control signal includes the second control signal pattern of the detected power line control signal.

While the preferred embodiment of the invention has been illustrated and described, as noted above, many changes can be made without departing from the spirit and scope of the invention. For example, the coupling units may transmit and/or receive using frequencies other than 310 MHz. Additionally, the coupling units may be configured using various combinations of hardware and software that may include microcontrollers, application specific integrated circuits (ASICs), and/or systems on a chip (SOC), for example. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A power line control signal coupler comprising:
a transceiver configured to detect and modulate control signals present on a power line;
a wireless transmitting component;
a wireless receiving component; and
a processor in communication with the transceiver, the transmitting component, and the receiving component, wherein
the processor is configured to cause the transmitting component to transmit wireless signals based on power line signals detected by the transceiver and further configured to identify wireless signals received at the wireless receiving component as originating from a similarly configured power line control signal coupler and to instruct the transceiver to modulate the power signal based on the identified wireless signals.

2. The power line control signal coupler of claim 1, wherein the transceiver comprises:
a power line control signal detecting component; and
a power signal modulating component.

3. The power line control signal coupler of claim 1, further comprising a plug component in communication with the transceiver, wherein the plug component is configured to plug into a standard household power outlet.

4. The power line control signal coupler of claim 3, wherein the plug component is configured to plug into a 110 VAC household power outlet.

5. The power line control signal coupler of claim 1, wherein the transceiver is configured to detect signals encoded with an X10 protocol and modulate the power signal with signals using the X10 protocol.

6. The power line control signal coupler of claim 1, wherein the transmitting component and the receiving component are configured to operate at approximately 310 MHz.

7. The power line control signal coupler of claim 1, further comprising a port in signal communication with the processor configured such that the processor can accept instructions from a device in signal communication with the port, wherein the processor is further configured to instruct the transceiver to modulate the power signal based on the instructions from the device and further configured to instruct the transmitting component to transmit wireless signals based on the instructions from the device.

8. A power line control signal coupling system comprising:
a first coupling unit configured for connection to a first power line carrying an electrical current at a first phase, the first coupling unit having a signal detector to detect signals traveling on the power line and a wireless transmitter to wirelessly transmit the signals; and
a second coupling unit configured for connection to a second power line carrying an electrical current at a second phase, the second coupling unit having a receiver to receive the signals wirelessly transmitted by the first coupling unit and a transceiver configured to modulate the signals onto the second power line;
whereby the signals detected on the first power line at the first phase are transferred to the second power line at the second phase.

9. The power line control signal coupling system of claim 8, wherein the power line is a 110 VAC power line and wherein the first and second coupling units each include a standard plug configured to plug into a 110 VAC power outlet.

10. The power line control signal coupling system of claim 9, wherein the first and second coupling units are each configured to modulate the signal using an X10 protocol.

11. The power line control signal coupling system of claim 9, wherein the wireless signal is transmitted at a frequency of approximately 310 MHz.

12. A method of coupling a power line control signal having a control signal pattern from a first power line carrying a first power signal to a second power line carrying a second power signal, the method comprising:
detecting the power line control signal on the first power line using a first coupling unit;
transmitting a wireless signal from the first coupling unit based on the detected power line control signal;
receiving the wireless signal at a second coupling unit; and
modulating the second power signal with a coupled power line control signal based on the received wireless signal using the second coupling unit such that the coupled power line control signal includes the control signal pattern of the detected power line control signal.

13. The method of claim 12, wherein the second power signal has a different phase than the first power signal.

14. The method of claim 12, wherein the second coupling unit is substantially similar to the first coupling unit.

15. The method of claim 12, further comprising:
detecting a power line control signal having a control signal pattern on the second power line using the second coupling unit;
transmitting a wireless signal from the second coupling unit based on the power line control signal detected on the second power line;
receiving the wireless signal from the second coupling unit at the first coupling unit; and
modulating the first power signal with a coupled power line control signal based on the received wireless signal from the second coupling unit using the first coupling unit such that the coupled power line control signal includes the control signal pattern of the detected power line control signal on the second power line.

16. The method of claim 15, further comprising:
plugging the first coupling unit into a first standard electrical outlet electrically connected to the first power line; and
plugging the second coupling unit into a second standard electrical outlet electrically connected to the second power line.

17. The method of claim 16, wherein the first power line is a standard household power line and the second power line is a standard household power line.

18. The method of claim 17, wherein the first power line is a 110 VAC power line and the second power line is a 110 VAC power line.

19. The method of claim 18, wherein modulating the second power signal includes modulating the second power signal using an X10 protocol and wherein modulating the first power signal includes modulating the first power signal using an X10 protocol.
